(19) United States
(12) Patent Application Publication
(10) Pub. No.: US 2025/0332998 A1
(43) Pub. Date: Oct. 30, 2025

(54) SYSTEMS AND METHODS FOR FACILITATING VEHICLE ENERGY TRANSFER

(71) Applicant: Ford Global Technologies, LLC, Dearborn, MI (US)

(72) Inventors: Stuart C. Salter, White Lake, MI (US); Ryan O'Gorman, Beverly Hills, MI (US); Stan Bradbury, Saline, MI (US); Peter J. Nikolajevs, Dearborn, MI (US); Furkhan Syed, Farmington Hills, MI (US); Andrew Erich Mast, Northville, MI (US)

(73) Assignee: Ford Global Technologies, LLC, Dearborn, MI (US)

(21) Appl. No.: 18/644,234

(22) Filed: Apr. 24, 2024

(51) Int. Cl. B60R 3/02; B62D 33/027; H02J 50/10; H02J 50/90

(52) U.S. Cl. CPC B60R 3/02; B62D 33/0273; H02J 50/10; H02J 50/90

(57) ABSTRACT

A first vehicle having a tailgate, a step support structure and a first charging coil is disclosed. The step support structure may be configured to slide in and out of a tailgate interior portion. The first charging coil may be connected to the step support structure. The first charging coil may be configured to couple with a second charging coil disposed on a second vehicle. The first charging coil and the second charging coil may be configured to transfer energy between the first vehicle and the second vehicle when the first charging coil and the second charging coil may be coupled with each other.

### BACKGROUND

Vehicle users may regularly require transferring energy from or to their vehicles. For example, a vehicle user may require to transfer energy from a vehicle's onboard battery to an external equipment (e.g., an electric tool), to operate the equipment. Similarly, the vehicle user may require to transfer energy from an external energy source to the vehicle's onboard battery when, for example, the vehicle battery's State of Charge (SoC) level may be low.

It is also known that when a vehicle is connected to a trailer, the vehicle may transfer energy from the vehicle's battery to the trailer to operate one or more trailer components (lights, entertainment system, etc.). Further, when the vehicle is an electric vehicle (EV) and the trailer is an electric trailer, energy may be made to flow bi-directionally between the EV and the trailer based on the SOC levels of respective batteries of the EV and the trailer.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a first vehicle connected to a second vehicle in accordance with the present disclosure.

FIG. 2A depicts a tailgate associated with a vehicle in a closed position and a step support structure in a retracted position in accordance with the present disclosure.

FIG. 2B depicts a tailgate associated with a vehicle in an open position and a step support structure in a partially extended position in accordance with the present disclosure.

FIG. 2C depicts a tailgate associated with a vehicle in an open position and a step support structure in a fully extended position in accordance with the present disclosure.

FIG. 3 depicts a first example arrangement of a first vehicle charging coil coupled with a second vehicle charging coil in accordance with the present disclosure.

FIG. 4 depicts a second example arrangement of a first vehicle charging coil coupled with a second vehicle charging coil in accordance with the present disclosure.

FIG. 5 depicts a third example arrangement of a first vehicle charging coil coupled with a second vehicle charging coil in accordance with the present disclosure.

FIG. 6 depicts a fourth example arrangement of a first vehicle charging coil coupled with a second vehicle charging coil in accordance with the present disclosure.

FIG. 7 depicts a flow diagram of an example method for facilitating energy transfer between a first vehicle and a second vehicle in accordance with the present disclosure.

### DETAILED DESCRIPTION

### Overview

The present disclosure describes a vehicle that may be configured to transfer or receive energy to/from an external system or another vehicle. For example, the vehicle may be configured to transfer/receive energy to/from a trailer that may be connected with the vehicle. In some aspects, the energy may be transferred between the vehicle and the trailer wirelessly, e.g., via induction.

The vehicle may include a tailgate that may be configured to move between an open position and a closed position. The vehicle may further include a step support structure that may be configured to slide in and out of a tailgate interior portion. The step support structure may be configured to move between a retracted position, a partially extended position and a fully extended position. The step support structure may be in the retracted position when the step support structure may be fully disposed or stowed inside the tailgate interior portion. The step support structure may be in the partially extended position when the step support structure may be partially outside the tailgate interior portion. In some aspects, a step support structure plane may be parallel to a tailgate plane when the step support structure may be in the partially extended position. Further, the step support structure may be in the fully extended position when the step support structure may be fully outside the tailgate interior portion. In some aspects, the step support structure plane may be inclined at a predefined non-zero angle relative to the tailgate plane when the step support structure may be in the fully extended position.

A charging pad or a charging coil (e.g., a first charging coil) may be connected to a bottom surface or an underside of the step support structure. The first charging coil may be an inductive power transfer coil that may be configured to transfer energy to another charging coil (e.g., a second charging coil that may be disposed on a fastening means attaching the vehicle and the trailer), when the first charging coil contacts the other charging coil or is in proximity to the other charging coil.

In some aspects, the first charging coil may be electrically coupled with a vehicle battery, and the second charging coil may be electrically coupled with a trailer battery. To enable energy transfer between the vehicle and the trailer, a vehicle user may move the tailgate to the open position, and then move the step support structure either to the partially extended position or the fully extended position. In this arrangement, the first charging coil may get aligned with the second charging coil. The fastening means attaching the vehicle and the trailer may further include a spring load piston that may push or force the second charging coil towards the first charging coil, causing the first and second charging coils to touch or be in proximity to each other, when the first charging coil may be aligned with the second charging coil. When the first and second charging coils contact each other or are disposed in proximity to each other, electric energy may flow between the first and second charging coils via induction, thereby enabling energy transfer between the vehicle battery and the trailer battery.

The present disclosure discloses a vehicle that may enable energy transfer to other systems/vehicles wirelessly, without requiring any cables. Further, the vehicle uses existing hardware to enable energy transfer, and thus does not require installation of any external component/hardware. Furthermore, the vehicle charging coil can be easily stowed in the tailgate interior portion, thereby preventing the coil from ambient environment, when the coil may not be in use.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

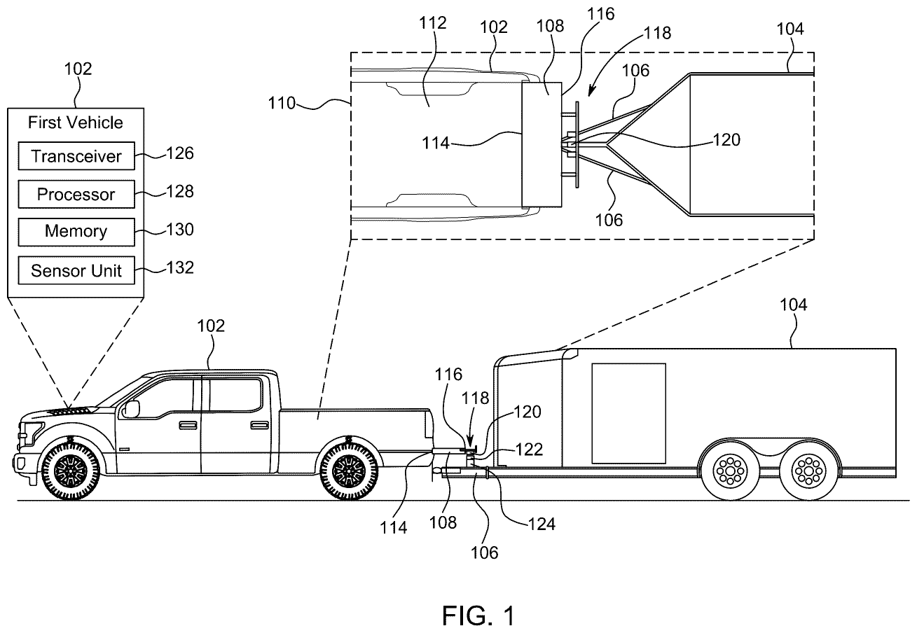

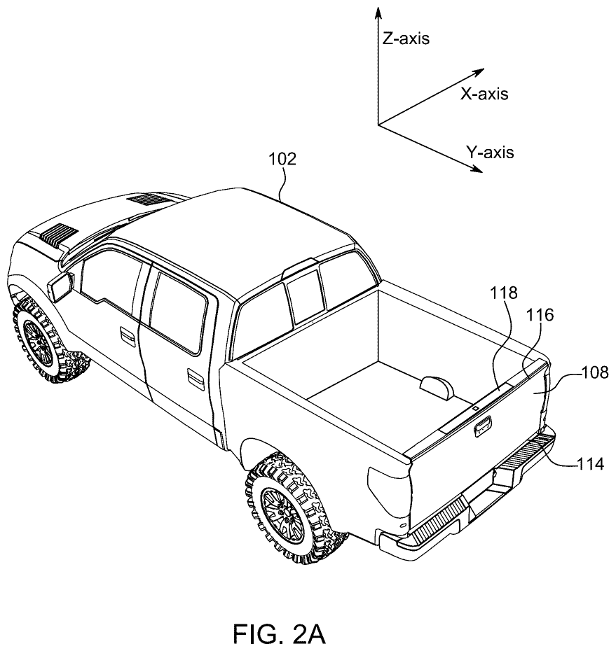

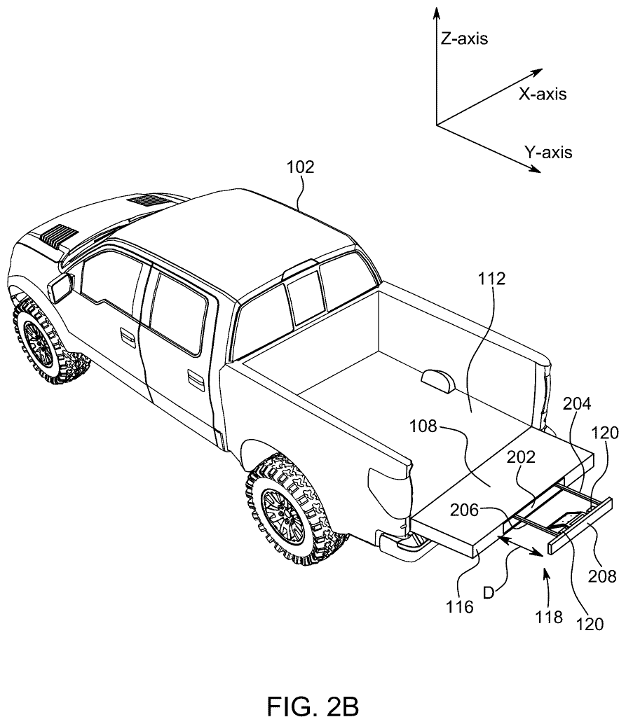

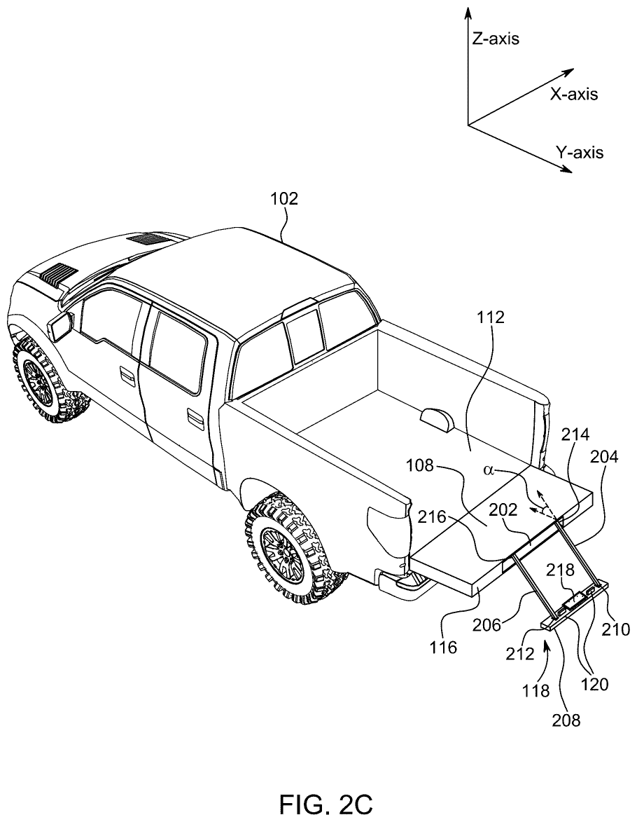

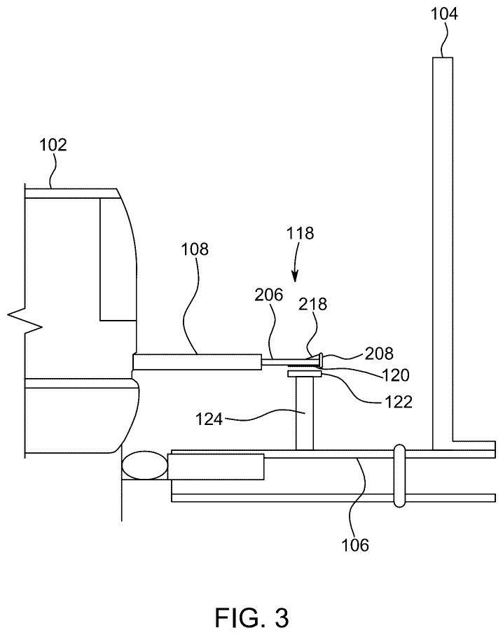

FIG. 1 depicts a first vehicle 102 connected to a second vehicle 104 in accordance with the present disclosure. FIG. 1 will be described in conjunction with FIGS. 2A, 2B, 2C and 3. In some aspects, the first vehicle 102 may be electrically and mechanically connected with the second vehicle 104. The first vehicle 102 may take the form of any passenger or commercial vehicle such as a car, an off-road vehicle, a work vehicle, a crossover vehicle, a van, a minivan, a taxi, a bus, a truck, etc. Further, the first vehicle 102 may be a manually driven vehicle, and/or may be configured to operate in partially or fully autonomous mode, and may include any powertrain such as a gasoline engine, one or more electrically-actuated motor(s), a hybrid system, etc. Further, in some aspects, the second vehicle 104 may be a trailer, as shown in FIG. 1. Hereinafter, the first vehicle 102 is referred to as vehicle 102, and the second vehicle 104 is referred to as trailer 104.

The trailer 104 may be attached to a vehicle rear portion (as shown in FIG. 1) by using mechanical and/or magnetic fasteners or fastening means and via electrical coupling. In an exemplary aspect, the fastening means may include one or more shafts 106 (or shaft 106) or any other conventional attachment means that may enable secure attachment between the vehicle 102 and the trailer 104. The example connection arrangement (including the shaft 106) between the vehicle 102 and the trailer 104 depicted in FIG. 1 and described herein should not be construed as limiting. The vehicle 102 and the trailer 104 may be mechanically and electrically attached with each other via any other known means, without departing from the present disclosure scope.

The trailer 104 may be a cargo trailer that may be used to transport goods, or may be a Recreational Vehicle (RV). In some aspects, the vehicle 102 may be configured to transfer energy stored in a vehicle's battery (not shown) to the trailer 104, to enable operation of one or more trailer components. For example, the vehicle 102 may transfer electric energy to the trailer 104 to enable operation of trailer's internal and external lights, entertainment system, heating, ventilation, and air conditioning (HVAC) system, and/or the like. In further aspects, when the vehicle 102 is an electric vehicle (EV) and the trailer 104 is an electric trailer, the trailer 104 may also transfer electric energy to the vehicle 102 when, e.g., a state of charge (SoC) level associated with the vehicle battery may be low. In this case, the vehicle 102 and the trailer 104 may be bidirectional EVs. In some aspects, the energy may be transferred between the vehicle 102 and the trailer 104 via wireless charging coils, e.g., induction coils, as described later in the description below.

In an exemplary aspect, the vehicle 102 may include a tailgate 108 that may be disposed at the vehicle rear portion. The tailgate 108 may be configured to move between an open position and a closed position. A vehicle's isometric view with the tailgate 108 in the closed position is shown in FIG. 2A. Further, vehicle's isometric views with the tailgate 108 in the open position are shown in FIGS. 2B and 2C. A vehicle's side view with the tailgate 108 in the open position is shown in FIG. 1. Further, a vehicle's top view with the tailgate 108 in the open position is shown as view 110 in FIG. 1.

The vehicle 102 may include a vehicle bed 112. In some aspects, the tailgate 108 may be in the closed position when a tailgate plane may be perpendicular to a vehicle bed plane and in the open position when the tailgate plane may be parallel to the vehicle bed plane. For example, as shown in FIG. 2B, the tailgate 108 is in the open position as both the tailgate plane and the vehicle bed plane are in the X-Y plane. On the other hand, as shown in FIG. 2A, the tailgate 108 is in the closed position as the tailgate plane is in the X-Z plane (and the vehicle bed plane is in the X-Y plane).

The tailgate 108 may include a tailgate proximal edge 114 and a tailgate distal edge 116. The tailgate proximal edge 114 may be pivotally connected (e.g., via a hinge, not shown) to a vehicle bed's rear edge, which may enable a vehicle user (not shown) to move/rotate the tailgate 108 between the open position and the closed position via the tailgate proximal edge 114.

The tailgate 108 may be moved between the open position and the closed position irrespective of the connection/attachment status between the vehicle 102 and the trailer 104. Stated another way, the tailgate 108 may be moved between the open and closed positions before or after the vehicle 102 is mechanically and electrically attached with the trailer 104. The tailgate movement is not hindered by the connection/fastening means that may connect the vehicle 102 with the trailer 104. For example, as shown in FIG. 1, the shaft 106 that connects the vehicle 102 and the trailer 104 may be attached to the vehicle 102 at an attachment point below the tailgate proximal edge 114, thereby not hindering the tailgate's rotational movement between the closed position and the open position when the vehicle 102 is connected with the trailer 104.

In some aspects, the vehicle user may move the tailgate 108 to the open position after connecting the vehicle 102 with the trailer 104 via the shaft 106. In other aspects, the vehicle user may first move the tailgate 108 to the open position and then connect the vehicle 102 with the trailer 104 via the shaft 106, without departing from the present disclosure scope.

The vehicle 102 may further include a step support structure 118 that may be connected to the tailgate distal edge 116 and configured to slide in and out of a tailgate interior portion. In some aspects, the tailgate interior portion may include a cavity 202 (as shown in FIGS. 2B and 2C) that may be accessed via the tailgate distal edge 116. The vehicle user may slide the step support structure 118 into the cavity 202 to stow the step support structure 118 in the tailgate interior portion and may pull the step support structure 118 out of the cavity 202 to slide the step support structure 118 from the tailgate interior portion.

In some aspects, the vehicle user may slide the step support structure 118 out of the tailgate interior portion after moving the tailgate 108 to the open position, as shown in FIGS. 2B and 2C. The step support structure 118 may enable the vehicle user to conveniently enter or exit the vehicle bed 112. For example, when the vehicle user desires to enter the vehicle bed 112 from ground, the vehicle user may move the tailgate 108 to the open position and slide the step support structure 118 out of the tailgate interior portion. The vehicle user may then place the user's foot on the step support structure 118 and use the step support structure 118 as a “step” (e.g., like a step of a ladder) to conveniently enter the vehicle bed 112 from the ground. The vehicle user may similarly use the step support structure 118 to conveniently return to the ground from the vehicle bed 112.

In some aspects, the step support structure 118 may be a rectangular frame or a square-shaped frame that may include a first rail 204, a second rail 206 and a third rail 208, as shown in FIGS. 2B and 2C. Each rail of the first rail 204, the second rail 206 and the third rail 208 may be an elongated structural member (e.g., like a tube or a rod) which may be cylindrical or cuboidal in shape. In an exemplary aspect, the first rail 204, the second rail 206 and the third rail 208 may be made of nonconductive reinforced plastic. In other aspects, the first rail 204, the second rail 206 and the third rail 208 may be made of any other electrically nonconductive material.

A first rail length may be equivalent to a second rail length. Further, a third rail length may be same as or different from the first length and the second length. Furthermore, a first rail longitudinal axis may be parallel to a second rail longitudinal axis, and a third rail longitudinal axis may be perpendicular to the first rail longitudinal axis and the second rail longitudinal axis, thereby forming a rectangular or square-shaped frame. As shown in FIG. 2C, a first rail distal end 210 and second rail distal end 212 may be attached to the third rail 208. In an exemplary aspect, the first rail distal end 210 may be attached to a third rail proximal surface or a third rail proximal end (not shown), and the second rail distal end 212 may be attached to a third rail distal surface or a third rail distal end (not shown). Further, the first rail 204 may be connected to the tailgate distal edge 116 via a first rail proximal end 214, and the second rail 206 may be connected to the tailgate distal edge 116 via the a second rail proximal end 216. In some aspects, the step support structure 118 may be configured to slide in and out of the tailgate interior portion via the first rail proximal end 214 and the second rail proximal end 216.

In some aspects, the step support structure 118 may further include an inclined step surface 218 that may be disposed on a third rail center portion, as shown in FIG. 2C. The inclined step surface 218 may facilitate the vehicle user to conveniently place the user's foot on the step support structure 118 and enter/exit the vehicle bed 112. In some aspects, the inclined step surface 218 may be made of the same material as the first, second and third rails 204, 206 and 208.

The example step support structure shape depicted in FIGS. 2B and 2C, and described above, should not be construed as limiting. The step support structure 118 may have any other shape, without departing from the present disclosure scope. For example, in some aspects, the step support structure 118 may not include the inclined step surface 218, but may include any other means to enable the vehicle user to conveniently enter and exit the vehicle bed 112 via the step support structure 118. As another example, in some aspects, the step support structure 118 may not be shaped as a rectangular or square-shaped frame, and may have any other shape.

In some aspects, the step support structure 118 may be configured to move between a retracted position, a partially extended position and a fully extended position relative to the tailgate 108. The step support structure 118 may be disposed fully inside the tailgate interior portion when the step support structure 118 may be in the retraced position, as shown in FIG. 2A. As depicted in FIG. 2A, the step support structure 118 (specifically, the third rail 208) may lay flush with the surface of the tailgate distal edge 116 when the step support structure 118 may be in the retraced position.

The step support structure 118 may be disposed partially outside the tailgate interior portion when the step support structure 118 may be in the partially extended position, as shown in FIG. 2B. In some aspects, the step support structure 118 may be configured to be “locked” in different partially extended positions, such that a distance “D” between the third rail 208 and the tailgate distal edge 116 may be changed. The vehicle user may lock the step support structure 118 is a desired partially extended position (i.e., associated with a desired distance “D”) based on user's requirements and structural details associated with the vehicle 102, the trailer 104 and the fastening means (e.g., the shaft 106) that connects the vehicle 102 with the trailer 104. The concept of locking the step support structure 118 in the desired partially extended position is described later in the description below.

In some aspects, the step support structure 118 may be locked in different partially extended positions by any known locking means, e.g., by using detents, spring loaded retention latches, magnets disposed on the trailer 104 (and/or the vehicle 102), and/or the like.

In an exemplary aspect, when the step support structure 118 is in the partially extended position, a step support structure plane may be parallel to the tailgate plane. For example, as shown in FIG. 2B, both the step support structure plane and the tailgate plane are aligned in the X-Y plane, when the step support structure 118 is in the partially extended position. In further aspects, when the tailgate 108 is in the open position and the step support structure 118 is in the partially extended position, the step support structure plane, the tailgate plane, and the vehicle bed plane may be aligned parallel to each other and aligned parallel to ground (when the vehicle 102 is located on a flat ground/surface).

The step support structure 118 may be disposed fully outside the tailgate interior portion when the step support structure 118 may be in the fully extended position, as shown in FIG. 2C. In the fully extended position, the first rail 204 and the second rail 206 may be fully extended out of the tailgate interior portion. Stated another way, entire first rail length and second rail length may be out of the tailgate interior portion when the step support structure 118 is in the fully extended position. In some aspects, the step support structure plane may be aligned at a predefined non-zero angle “a” relative to the tailgate plane when the step support structure 118 may be in the fully extended position and the tailgate 108 may be in the open position, as shown in FIG. 2C. The angle “a” may be in a range of 40 to 60 degrees. In some aspects, the step support structure 118 may be pivotally connected (via hinges, not shown) to the tailgate distal edge 116 via the first and second rail proximal ends 214, 216. When the tailgate 108 is in the open position and the vehicle user fully slides/pulls the step support structure 118 out of the tailgate interior portion, the step support structure 118 may automatically move “downwards” towards the ground (under the force of gravity) such that the step support structure plane gets aligned at the angle “a” relative to the tailgate plane. A person ordinarily skilled in the art may appreciate that such a fully extended position of the step support structure 118 may facilitate the vehicle user to conveniently use the step support structure 118 to enter/exit the vehicle bed 112.

In further aspects, the vehicle 102 may include one or more first charging pads or first charging coils 120 (or first charging coil 120) that may be connected/attached to a bottom portion or underside of the step support structure 118, as shown in FIG. 1. A zoomed-in side view of the first charging coil 120 connected to the step support structure 118 is shown in FIG. 3. FIG. 3 specifically depicts an aspect where the step support structure 118 is locked in the partially extended position and the tailgate 108 is in the open position. As described above, in this configuration/arrangement the step support structure plane is aligned parallel to the tailgate plane (which itself is aligned parallel to the vehicle bed plane and the ground surface).

In some aspects, the first charging coil 120 may be attached to the bottom portion or underside of the step support structure 118 such that the first charging coil 120 may face the ground (or may face “downwards”) when the step support structure 118 may be in the partially extended position and the tailgate 108 may be in the open position. Further, the first charging coil 120 may be attached to the bottom portion or underside of the step support structure 118 such that a first charging coil plane (or a first charging pad plane) may be parallel to the step support structure plane. Therefore, the first charging coil plane may be parallel to the ground surface when the step support structure 118 may be in the partially extended position and the tailgate 108 may be in the open position, as shown in FIG. 3.

In an exemplary aspect, the first charging coil 120 may be inductive power transfer coils that may be packaged as a rectangular or circular charging pad (or charging pad of any other shape) and attached to the underside of the step support structure 118. The first charging coil 120 may be configured to transfer energy (e.g., electric energy) to/from the vehicle 102 via induction, when the first charging coil 120 is in contact with (or in proximity to) another charging coil/pad (e.g., a second charging coil 122, described below). In some aspects, the first charging coil 120 may be attached to any one or more of the first rail 204, the second rail 206 and/or the third rail 208. Since the first charging coil 120 is attached to the first rail 204, the second rail 206 and/or the third rail 208, the first charging coil 120 moves along with the step support structure 118 as the step support structure 118 is moved between the retraced position, the partially extended position and the fully extended position. For example, the first charging coil 120 may move into the tailgate interior position (thus protecting the first charging coil 120 from ambient environment) when the step support structure 118 is stowed in the retracted position. In this manner, the first charging coil 120 may be protected from dust, debris, pollution, etc., when the first charging coil 120 may not be required to be used. The vehicle user may move the step support structure 118 to the partially extended position or the fully extended position (thus pulling the first charging coil 120 out of the tailgate interior portion), when the vehicle user desires to use the first charging coil 120.

In an exemplary aspect, the first charging coil 120 may be attached to the step support structure 118 such that the first charging coil 120 is disposed in proximity to the third rail 208, as shown in FIG. 3. The example arrangement depicted in FIG. 3 should not be construed as limiting. In other aspects, the first charging coil 120 may be attached to the step support structure 118 in any other position (e.g., away from the third rail 208), without departing from the present disclosure scope.

Furthermore, the trailer 104 may include or be electrically connected with a second charging pad or a second charging coil 122. The second charging coil 122 may be associated with the trailer 104 and may be similar to the first charging coil 120. The second charging coil 122 may be configured to transfer energy (e.g., electric energy) to/from the trailer 104 via induction, when the second charging coil 122 is in contact with (or in proximity to) another charging coil/pad (e.g., the first charging coil 120).

The first charging coil 120 and the second charging coil 122 may be configured to electrically couple with each other when the first charging coil 120 and the second charging coil 122 are disposed in proximity to each other or come in contact with each other. The first charging coil 120 and the second charging coil 122 may be configured to enable electric energy transfer between the vehicle 102 and the trailer 104 via induction, when the first charging coil 120 and the second charging coil 122 may be coupled with each other. In an exemplary aspect, the first charging coil 120 may be coupled with a vehicle battery and configured to draw electric energy from the vehicle battery (e.g., via a vehicle power outlet, not shown) and transfer the energy to the second charging coil 122 when the first and second charging coils 120, 122 may be coupled with each other. The second charging coil 122 may in turn be coupled with a trailer battery and may transfer the electric energy obtained from the first charging coil 120 to the trailer battery. A similar, but reverse, process may be followed when electric energy is transferred from the trailer battery to the vehicle battery.

In some aspects, the energy transfer from/to the vehicle battery via the first charging coil 120 (and the vehicle power outlet) may be controlled (e.g., enabled or disabled) by a vehicle processor, which is described later in the description below.

In an exemplary aspect, the second charging coil 122 may be disposed on or connected to the shaft 106 (or any other fastening means or structure that may be used to connect the vehicle 102 with the trailer 104) such that a second charging coil plane may be parallel to the ground surface, as shown in FIG. 3. Further, since the first charging coil plane is parallel to the ground surface when the step support structure 118 is in the partially extended position and the tailgate 108 is in the open position (as described above and as shown in FIG. 3), the first charging coil plane is parallel to the second charging coil plane when the step support structure 118 is in the partially extended position and the tailgate 108 is in the open position.

In some aspects, the second charging coil 122 may be connected to the shaft 106 via a spring load piston 124 (or piston 124) associated with the trailer 104. Piston's one end may be attached to the shaft 106 and piston's other end may be attached to the second charging coil 122 or disposed in proximity to the second charging coil 122, as shown in FIG. 3. The piston 124 may be configured to provide an upward force or an upward push to the second charging coil 122 so that the second charging coil 122 may touch or contact (and stay in contact with) the first charging coil 120 or be in proximity to the first charging coil 120, when the first charging coil 120 is disposed above the second charging coil 122 and the first charging coil plane is parallel to the second charging coil plane. The first charging coil 120 and the second charging coil 122 may electrically couple with each other and begin to (or be ready to) transfer energy when the first charging coil 120 contacts the second charging coil 122 or is in proximity to the second charging coil 122. In some aspects, the piston 124 may ensure that the first and second charging coils 120, 122 stay in contact with each other or stay in proximity to each other (and thus continue to transfer energy) even when the vehicle 102 and the trailer 104 may be moving on a road (and may thus have some movement relative to each other). The energy transfer may automatically stop when the first and second charging coils 120, 122 become misaligned relative to each other.

In operation, when the vehicle user desires to transfer electric energy between the vehicle 102 and the trailer 104 connected to the vehicle 102, the user may first move the tailgate 108 to the open position. The user may then slide out the step support structure 118 from the tailgate interior portion to an optimal or desired partially extended position. In some aspects, the optimal partially extended position may be that position at which the first charging coil 120 may get aligned with the second charging coil 122 or the position at which the first charging coil 120 may be disposed above (or on top of) the second charging coil 122, as shown in FIG. 3. The user may then lock the step support structure 118 in the optimal partially extended position.

When the step support structure 118 may be locked in the optimal partially extended position, the piston 124 may push the second charging coil 122 upwards, thereby causing the first charging coil 120 to contact the second charging coil 122 or be in proximity to the second charging coil 122, and electrically coupling the first and second charging coils 120, 122. At this point, the vehicle processor may cause energy to flow from the vehicle battery to the first charging coil 120 (e.g., via the vehicle power outlet). The energy may then get transferred to the second charging coil 122 via induction and may finally get transferred to the trailer battery (which may be electrically connected to the second charging coil 122). In this manner, the energy may flow from the vehicle 102 to the trailer 104. A similar, but reverse, process may be followed when the energy flows from the trailer 104 to the vehicle 102 via the first and second charging coils 120, 122.

In further aspects, the vehicle 102 may include one or more additional components/units including, but not limited to, a transceiver 126, a processor 128, a memory 130, and a sensor unit 132. The transceiver 126 may be configured to transmit/receive signals/data/notifications, etc. to/from one or more external devices or systems, e.g., components associated with the trailer 104, a user device, an external server (not shown), and/or the like via a wired or wireless network. The network, as described herein, illustrates an example communication infrastructure in which the connected devices discussed in various embodiments of this disclosure may communicate. The network(s) may be and/or include the Internet, a private network, public network or other configuration that operates using any one or more known communication protocols such as, for example, transmission control protocol/Internet protocol (TCP/IP), Bluetooth®, Bluetooth Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the sensor unit 132 may include one or more vehicle sensors including, but not limited to, interior and external vehicle cameras, a radio detection and ranging (radar) sensor, a light detection and ranging (lidar) sensor, and/or the like. The sensor unit 132 may be configured to capture inputs associated with the surrounding of the vehicle 102. For example, the sensor unit 132 may be configured to capture images of vehicle's surroundings.

The processor 128 may be disposed in communication with one or more memory devices (e.g., the memory 130 and/or one or more external databases not shown in FIG. 1). The processor 128 may utilize the memory 130 to store programs in code and/or to store data for performing various vehicle operations in accordance with the present disclosure. The memory 130 may be a non-transitory computer-readable storage medium or memory storing computer-executable instructions which when executed by the processor 128 enables the processor 128 to perform various vehicle operations. The memory 130 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.

In some aspects, the processor 128 may be configured to enable and disable energy flow into or from the first charging coil 120. For example, the processor 128 may enable or disable the flow of energy from the vehicle battery to the first charging coil 120 (and thus to the trailer 104). In further aspects, the processor 128 may be configured to obtain inputs from the sensor unit 132 and determine a user presence in proximity to the vehicle's rear portion or the step support structure 118 when the first charging coil 120 may be coupled with the second charging coil 122, based on the inputs obtained from the sensor unit 132. Responsive to determining the user presence as described above, the processor 128 may disable the energy transfer (or stop the flow of energy) between the vehicle 102 and the trailer 104 via the first and second charging coils 120, 122. Disabling the energy flow via the first and second charging coils 120, 122 in this case may prevent the user from any electromagnetic field (EMF) radiation exposure that may be caused due to induction charging.

The vehicle 102 may implement one or more additional measures to enhance user's convenience of using the first and charging coils 120, 122 to transfer energy between the vehicle 102 and the trailer 104. For example, the first rail 204, the second rail 206, the third rail 208 and the inclined step surface 218 may be electrically grounded, so that a “ring shield” may be formed around the first charging coil 120, which may assist in reducing the EMF radiation exposure.

Further, the material associated with the step support structure 118 may be made of nonconductive reinforced plastic, which may prevent heating during the energy transfer between the vehicle 102 and the trailer 104 via induction.

Furthermore, both the first and second charging coils 120, 122 may be molded to seal them and create a low friction interface. By having the first and second charging coils 120, 122 separated by only the thickness of the over-molding when the first and second charging coils 120, 122 contact each other, efficiency of energy transfer may be increased. Further, such structure may permit sizing of the coils to be at effective power ratings, while reducing radial size otherwise necessary to overcome air gaps between the coils.

Although the description above describes an aspect where energy is transferred between the vehicle 102 and the trailer 104 via the first charging coil 120, the present disclosure is not limited to such an aspect. In other aspects, energy may be transferred between the vehicle 102 and other systems (e.g., chargers, worksite power stations, etc.) via the first charging coil 120, in the similar manner as described above.

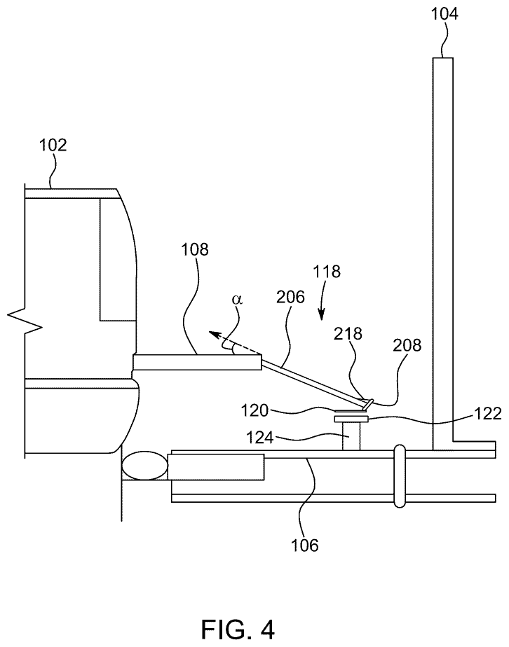

Furthermore, although the description above associated with FIG. 3 describes an aspect where energy is transferred between the vehicle 102 and the trailer 104 when the step support structure 118 is in the partially extended position, the present disclosure is not limited to such an aspect. In alternative aspects, energy may also be transferred between the vehicle 102 and the trailer 104 when the step support structure 118 may be in the fully extended position, as described below in conjunction with FIG. 4.

The vehicle 102 and/or the vehicle user implement and/or perform operations, as described here in the present disclosure, in accordance with the owner manual and safety guidelines.

FIG. 4 depicts a second example arrangement of the first charging coil 120 coupled with the second charging coil 122 in accordance with the present disclosure. FIG. 4 specifically depicts an arrangement where energy is transferred between the vehicle 102 and the trailer 104 via the first and second charging coils 120, 122 when the step support structure 118 may be in the fully extended position.

As described above and as shown in FIG. 4, when the step support structure 118 is in the fully extended position, the step support structure plane may be aligned at the angle “a” relative to the tailgate plane. In this case, the first charging coil 120 may be disposed/attached underneath the step support structure 118 or the third rail 208 (which may lay horizontal to the ground when the step support structure 118 is in the fully extended position), and get disposed parallel to and in proximity to the second charging coil 122 when the step support structure 118 is moved to the fully extended position. As described above, the first and second charging coils 120, 122 may electrically couple with each other and enable energy transfer (e.g., via induction) when the first and second charging coils 120, 122 are disposed parallel to and in proximity to each other.

As described above, when the first charging coil plane is aligned parallel to the second charging coil plane and the first charging coil 120 is disposed above the second charging coil 122, the piston 124 may push the second charging coil 122 upwards, thereby causing the first and second charging coils 120, 122 to contact or be in proximity to each other, and be electrically coupled with each other. In alternative aspects, the first and second rails 204, 206 may be free to pivot about the tailgate distal edge 116, which may enable the first charging coil 120 to “rest” upon the second charging coil 122, thereby not needing the piston 124 to push the second charging coil 122 upwards towards the first charging coil 120.

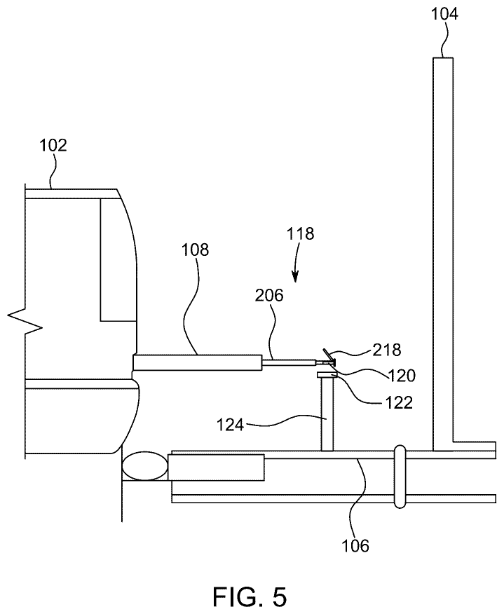

FIG. 5 depicts a third example arrangement of the first charging coil 120 coupled with the second charging coil 122 in accordance with the present disclosure. In some aspects, the first charging coil 120 may attached to a surface of the third rail 208 facing the tailgate 108 and under the inclined step surface 218. In this arrangement, the step support structure 118 may be moved to the partially extended position and then the third rail 208 may be titled/rotated down so that the first charging coil plane may become parallel to the second charging coil plane, as shown in FIG. 5. In this configuration, the first and second charging coils 120, 122 may contact and be electrically coupled with each other, to enable energy transfer between the first and second charging coils 120, 122, as described above.

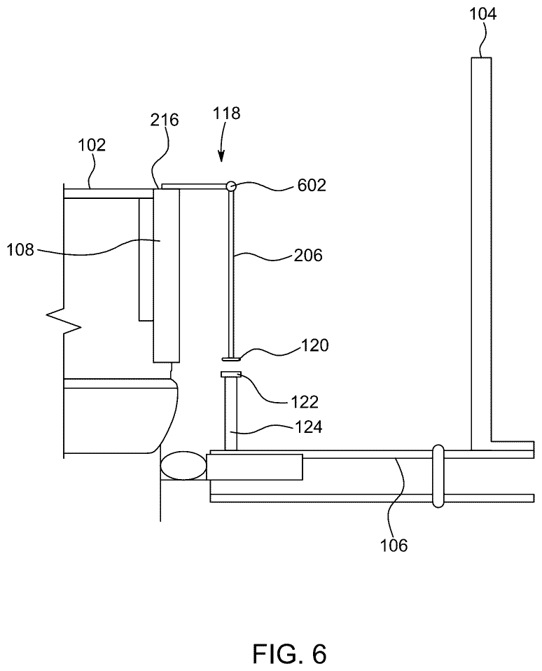

FIG. 6 depicts a fourth example arrangement of the first charging coil 120 coupled with the second charging coil 122 in accordance with the present disclosure. In some aspects, the step support structure 118 may be pivotally connected with the tailgate 108 via the first rail proximal end 214 and the second rail proximal end 216 that may enable the step support structure 118 to rotate relative to the tailgate plane. In further aspects, the first rail 204 may include a first hinge (not shown) disposed on a first rail body, and the second rail 206 may include a second hinge 602 disposed on a second rail body. The first rail 204 may be configured to axially rotate via the first hinge and the second rail 206 may be configured to axially rotate via the second hinge 602.

In this arrangement, the user may move the step support structure 118 out of the tailgate interior portion when the tailgate 108 may be in the closed position, and then rotate the first and second rails 204, 206 via respective hinges so that the first charging coil 120 may get aligned parallel to the second charging coil plane, and the first charging coil 120 may be disposed on top of the second charging coil 122, as shown in FIG. 6. In this state, the first and second charging coils 120, 122 may contact and be electrically coupled with each other, to enable energy transfer between the first and second charging coils 120, 122, as described above. This structure may enable the user to cause energy transfer between the vehicle 102 and the trailer 104, even when the tailgate 108 may be in the closed position.

In alternative aspects, the first charging coil 120 may not be attached to the step support structure 118 as described above and may instead be attached to any other structure/mechanism that may be hinged/pivotally attached to the tailgate 108 as shown in FIG. 6, to enable the first charging coil 120 to be placed on top of the second charging coil 122.

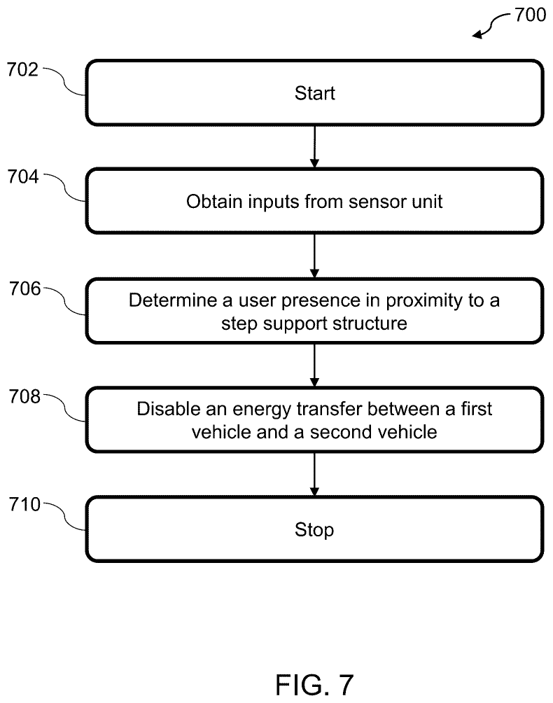

FIG. 7 depicts a flow diagram of an example method 700 for facilitating energy transfer between the vehicle 102 and the trailer 104 in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 7, at step 702, the method 700 may commence. At step 704, the method 700 may include obtaining, by the processor 128, the inputs from the sensor unit 132. At step 706, the method 700 may include determining, by the processor 128, the user presence in proximity to the vehicle's rear portion or the step support structure 118 when the first charging coil 120 may be coupled with the second charging coil 122, based on the inputs obtained from the sensor unit 132. At step 708, the method 700 may include disabling, by the processor 128, the energy transfer (or stopping the flow of energy) between the vehicle 102 and the trailer 104 via the first and second charging coils 120, 122, responsive to determining the user presence.

At step 710, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a tailgate;
a step support structure configured to slide in and out of a tailgate interior portion; and
a first charging coil connected to the step support structure, wherein the first charging coil is configured to couple with a second charging coil disposed on a second vehicle, and wherein the first charging coil and the second charging coil are configured to transfer energy between the first vehicle and the second vehicle when the first charging coil and the second charging coil are coupled with each other.

2. The first vehicle of claim 1, wherein the tailgate is configured to move between an open position and a closed position.

3. The first vehicle of claim 2 further comprising a first vehicle bed, wherein the tailgate is in the open position when a tailgate plane is parallel to a first vehicle bed plane, and wherein the tailgate is in the closed position when the tailgate plane is perpendicular to the first vehicle bed plane.

4. The first vehicle of claim 3, wherein the step support structure is configured to move between a retracted position, a partially extended position, and a fully extended position relative to the tailgate, and wherein the step support structure is disposed fully inside the tailgate interior portion in the retraced position, partially outside the tailgate interior portion in the partially extended position, and fully outside the tailgate interior portion in the fully extended position.

5. The first vehicle of claim 4, wherein the first charging coil is connected to the step support structure such that a first charging coil plane is parallel to a step support structure plane.

6. The first vehicle of claim 5, wherein the step support structure plane is aligned parallel to the tailgate plane when the step support structure is in the partially extended position and the tailgate is in the open position.

7. The first vehicle of claim 6, wherein the first charging coil plane is parallel to a second charging coil plane when the tailgate is moved to the open position and the step support structure is in the partially extended position.

8. The first vehicle of claim 7, wherein the second charging coil is connected to or disposed in proximity to a spring piston associated with the second vehicle, wherein the spring piston is configured to push the second charging coil towards the first charging coil such that the second charging coil contacts or is in proximity to the first charging coil when the first charging coil plane is parallel to the second charging coil plane, and wherein the first charging coil couples with the second charging coil when the first charging coil is in contact with or disposed in proximity to the second charging coil.

9. The first vehicle of claim 4, wherein a step support structure plane is aligned at a predefined non-zero angle relative to the tailgate plane when the step support structure is in the fully extended position and the tailgate is moved to the open position.

10. The first vehicle of claim 9, wherein the first charging coil contacts or is in proximity to the second charging coil and a first charging coil plane is parallel to a second charging coil plane when the step support structure plane is moved to the fully extended position, and wherein the first charging coil couples with the second charging coil when the first charging coil is in contact with the second charging coil.

11. The first vehicle of claim 1, wherein the second vehicle is a trailer connected with the first vehicle, and wherein the first charging coil and the second charging coil are induction coils configured to transfer energy via induction.

12. The first vehicle of claim 1, wherein the step support structure is a rectangular frame or a square-shaped frame comprising a first rail, a second rail, and a third rail, wherein:
a first rail longitudinal axis is parallel to a second rail longitudinal axis;
a third rail longitudinal axis is perpendicular to the first rail longitudinal axis and the second rail longitudinal axis;
a first rail distal end and a second rail distal end are connected to a third rail proximal end and a third rail distal end respectively; and
the step support structure is configured to slide in and out of the tailgate interior portion via a first rail proximal end and a second rail proximal end.

13. The first vehicle of claim 12, wherein the first charging coil is connected to at least one of the first rail, the second rail or the third rail.

14. The first vehicle of claim 12, wherein the first rail, the second rail and the third rail are electrically grounded.

15. The first vehicle of claim 12, wherein the step support structure is pivotally connected with the tailgate via the first rail proximal end and the second rail proximal end, wherein the first rail comprises a first hinge disposed on a first rail body, wherein the second rail comprises a second hinge disposed on a second rail body, and wherein the first rail is configured to axially rotate via the first hinge and the second rail is configured to axially rotate via the second hinge.

16. The first vehicle of claim 1 further comprising a sensor unit and a processor, wherein the sensor unit is configured to capture inputs associated with a first vehicle surrounding, and wherein the processor is configured to:
obtain the inputs from the sensor unit;
determine a user presence in proximity to the step support structure when the first charging coil and the second charging coil are coupled, based on the inputs; and
disable an energy transfer between the first vehicle and the second vehicle via the first charging coil and the second charging coil, responsive to determining the user presence.

17. A first vehicle comprising:
a tailgate;
a step support structure connected to an edge of the tailgate; and
a first charging coil connected to the step support structure, wherein:
the first charging coil is connected to the step support structure such that a first charging coil plane is parallel to a step support structure plane, and
the first charging coil is configured to couple with a second charging coil disposed on a second vehicle, and wherein the first charging coil and the second charging coil are configured to transfer energy between the first vehicle and the second vehicle when the first charging coil and the second charging coil are coupled with each other.

18. The first vehicle of claim 17, wherein the step support structure is configured to slide in and out of a tailgate interior portion.

19. A vehicle comprising:
a tailgate;
a step support structure configured to slide in and out of a tailgate interior portion, wherein:
the step support structure is configured to move between a retracted position, a partially extended position and a fully extended position relative to the tailgate,
the step support structure is disposed fully inside the tailgate interior portion in the retraced position, partially outside the tailgate interior portion in the partially extended position, and fully outside the tailgate interior portion in the fully extended position, and
a step support structure plane is aligned at a predefined non-zero angle relative to a tailgate plane when the step support structure is in the fully extended position; and
a first charging coil connected to the step support structure, wherein the first charging coil is configured to couple with a second charging coil disposed on a trailer connected with the vehicle, and wherein the first charging coil and the second charging coil are configured to transfer energy between the vehicle and the trailer when the first charging coil and the second charging coil are coupled with each other.

20. The vehicle of claim 19, wherein the first charging coil and the second charging coil are induction coils configured to transfer energy via induction.
